(19) United States
(12) Patent Application Publication
(10) Pub. No.: US 2008/0296477 A1
(43) Pub. Date: Dec. 4, 2008

(54) OPTICAL SYSTEM FOR INDUCING FOCUS DIVERSITY

(75) Inventor: Bruce H. Dean, New Market, MD (US)

Correspondence Address: NASA GODDARD SPACE FLIGHT CENTER, 8800 GREENBELT ROAD, MAIL CODE 140.1, GREENBELT, MD, 20771, US

(73) Assignee: U.S.A. as represented by the Administrator of the National Aeronautics and Space Adm., Washington, DC (US)

(21) Appl. No.: 11/469,002

(22) Filed: Aug. 31, 2006

Related U.S. Application Data
(60) Provisional application No. 60/713,616, filed on Aug. 31, 2005.

(51) Int. Cl. H01J 3/14; G02B 27/12

(52) U.S. Cl. 250/216; 359/639

(57) ABSTRACT

An optical system includes an optical element defining an optical axis and a focal plane and a defocus element disposed between the optical element and the focal plane. The defocus element includes at least one first lens for producing a positive defocus image of a light beam passing through the optical element, irrespective of a position of the first lens along the optical axis, and at least one second lens for producing a negative defocus image of the light beam passing through the optical element, irrespective of a position of the second lens along the optical axis.

### CROSS REFERENCE TO RELATED APPLICATIONS

The benefit of priority is claimed under 35 U.S.C. 119(e) of commonly assigned U.S. Provisional Patent Application No. 60/713,616, filed Aug. 31, 2005, entitled “Wavefront Sensing Devices and Methods,” which is incorporated by reference herein in its entirety.

### STATEMENT OF GOVERNMENT INTEREST

The invention described herein was made by an employee of the United States Government and may be manufactured and used by or for the Government of the United States of America for governmental purposes without the payment of any royalties thereon or therefor.

### FIELD OF THE INVENTION

The present invention relates to an optical system and, more particularly, to an optical system for inducing defocus in a light beam.

### BACKGROUND OF THE INVENTION

Wavefront sensing methods are used to measure the optical wavefront of a light beam produced by an optical element for the purpose of determining the optical imperfections (i.e., aberrations) of the element. Image-based wavefront sensing methods are a subset within the general class of wave front sensing methods in which a detector is used to collect optical data at a point where the optical element would normally form an image. One example of an image-based wavefront sensing method is described in commonly assigned U.S. patent application Ser. No. ______, Attorney Docket No. GSC 14,879-1, filed Aug. 31, 2006, which is incorporated by reference herein in its entirety.

Some image-based wavefront sensing methods utilize a diversity function, whereby a known aberration is induced to aid in the recovery of the unknown aberrations. In methods utilizing focus diversity, the known aberration is defocus. Image-based wavefront sensing methods utilizing focus diversity include phase retrieval methods, in which the object being viewed is known, as well as phase diversity methods, in which the object is unknown.

In conventional focus-diverse, image-based wavefront sensing methods, known levels of defocus are induced by physically moving the detector from its nominal focus position to multiple locations along the optical axis. There are several problems associated with this technique. First, the technique is labor intensive and prone to inaccuracies. For example, to obtain repeatable data, careful measurements of the detector positions with respect to a calibrated translation stage are required. Further, automation of the process requires expensive, additional equipment, such as an optical encoder stage, for example. Still further, the mechanical packaging of the detector may impede the required motion, particularly for optical elements having large focal lengths.

### SUMMARY OF EXEMPLARY EMBODIMENTS

In the following description, certain embodiments of the invention will become evident. It should be understood that the invention, in its broadest sense, could be practiced without having one or more features of these embodiments. It should also be understood that these embodiments are merely exemplary.

To overcome the drawbacks of the prior art and in accordance with the purpose of the invention, as embodied and broadly described herein, one embodiment of the invention relates to an optical system comprising an optical element defining an optical axis and a focal plane, and a defocus element disposed between the optical element and the focal plane. The defocus element may comprise at least one first lens for producing a positive defocus image of a light beam passing through the optical element, irrespective of a position of the first lens along the optical axis. The defocus element may further comprise at least one second lens for producing a negative defocus image of the light beam passing through the optical element, irrespective of a position of the second lens along the optical axis.

In another embodiment, the invention relates to an optical system comprising an optical element defining an optical axis and a focal plane, a detector disposed substantially in the focal plane to detect a light beam passing through the optical element, and a defocus element disposed between the optical element and the detector. The defocus element may comprise a support element, a plurality of first lenses associated with the support element for producing positive defocus images of the light beam on the detector, irrespective of a position of the plurality of first lenses along the optical axis, and a plurality of second lenses associated with the support element for producing negative defocus images of the light beam on the detector, irrespective of a position of the plurality of second lenses along the optical axis.

As used herein, “detector” means an analog-to-digital converter that converts light to digital format. Examples of detectors include at least charge coupled devices (CCDs), pixel arrays, bolometer arrays, and other imaging systems.

Aside from the structural and procedural arrangements set forth above, the invention could include a number of other arrangements, such as those explained hereinafter. It is to be understood that both the foregoing description and the following description are exemplary only.

### BRIEF DESCRIPTION OF THE DRAWINGS

The accompanying drawings, which are incorporated in and constitute a part of this specification, illustrate several exemplary embodiments of the invention and, together with the description, serve to explain the principles of the invention. In the drawings,

FIG. 1 is a schematic view of an optical system in accordance with an embodiment of the invention;

FIG. 2 is an embodiment of a defocus element according to the invention;

FIG. 3 is another embodiment of a defocus element according to the invention;

FIG. 4 is another embodiment of a defocus element according to the invention;

FIG. 5 is another embodiment of a defocus element according to the invention; and

FIG. 6 is a chart comparing defocus image data obtained using an embodiment of an optical system according to the invention.

### DETAILED DESCRIPTION OF EXEMPLARY EMBODIMENTS

Reference will now be made in detail to exemplary embodiments of the invention, examples of which are illustrated in the accompanying drawings. Wherever possible, the same reference numbers will be used throughout the drawings to refer to the same or the parts.

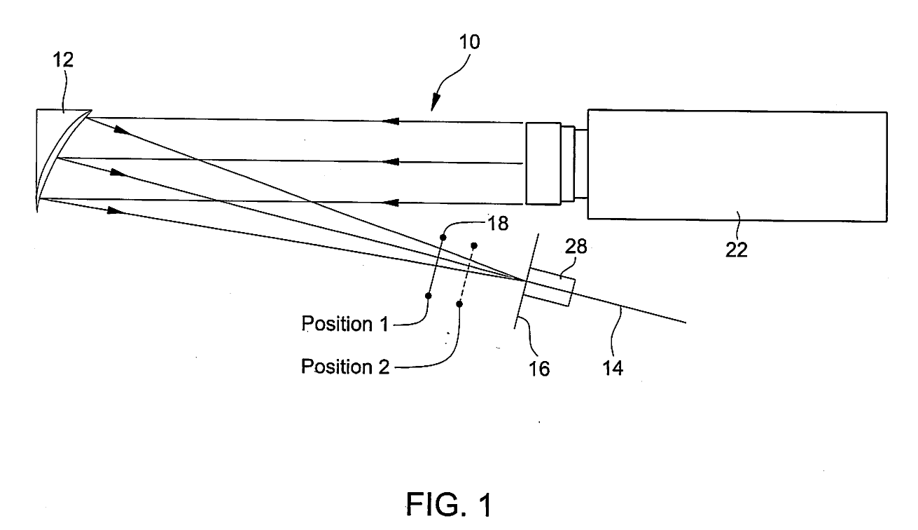

The optical system of the present invention may obviate the need to physically move the detector to induce defocus. An embodiment of the optical system 10 of the present invention is shown in FIG. 1. As shown, the system 10 comprises an optical element 12 defining an optical axis 14 and a focal plane 16. The optical element 12 shown is a parabolic mirror. Other types of optical elements may also be used, including at least one of a lens, a mirror, an imaging system, a camera, a detector, and a laser. Compound optical elements including combinations of those elements may also be used.

The focal plane 16 is defined as the plane perpendicular to the optical axis 14 that contains the focal point.

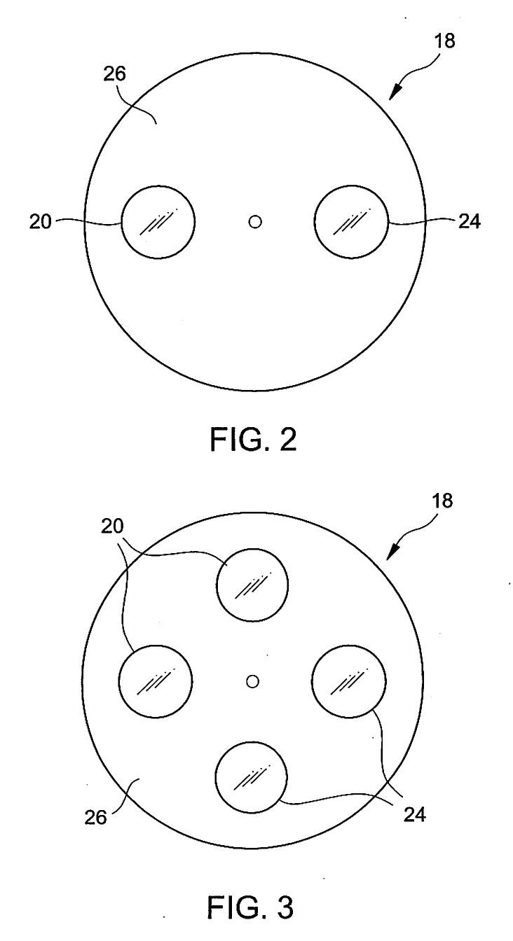

As shown in FIG. 1, a defocus element 18 is disposed between the optical element 12 and the focal plane 16. The defocus element 18, described below with reference to FIG. 2, comprises at least one first lens 20 for producing a positive defocus image of a light beam passing through the optical element 12, irrespective of a position of the first lens 20 along the optical axis 14. The light beam originates from a light source 22. The defocus element 18 may further comprise at least one second lens 24 for producing a negative defocus image of the light beam passing through the optical element 12, irrespective of a position of the second lens 24 along the optical axis 14.

As used herein, “positive defocus” means the focal point has been moved away from the optical element 12 along the optical axis 14. “Negative defocus” means the focal point has been moved toward the optical element 12 along the optical axis 14.

Optical data that includes both a positive defocus image and a negative defocus image may be useful in wavefront sensing methods to cancel out asymmetrical aberrations, which are artificial aberrations that would otherwise degrade the accuracy of the retrieved wavefront data characterizing the optical element.

In the embodiment shown in FIG. 2, the defocus element 18 comprises one first lens 20 and one second lens 24. In an alternative embodiment, shown in FIG. 3, the defocus element 18 comprises a plurality of first lenses 20 and a plurality second lenses 24. In embodiments where the defocus element 18 comprises a plurality of first lenses 20 and a plurality second lenses 24, the plurality of lenses may induce varying levels of defocus.

In some embodiments, the first lens 20 and the second lens 24 are selectively movable to a position substantially coaxial with the optical axis 14. In such an arrangement, a lens may be selectively moved into position to allow a corresponding defocus image to be obtained. Subsequently, that lens may be moved away from the optical axis 14 so that another lens may be moved into place for the next defocus image to be obtained.

In the embodiment shown in FIG. 2, the defocus element 18 further comprises a support element 26 supporting the at least one first lens 20 and the at least one second lens 24. In the embodiment shown, the defocus element 18 comprises one first lens 20 and one second lens 24. As discussed above, the defocus element 18 may also comprise a plurality of first lenses 20 and second lenses 24, as shown in FIG. 3.

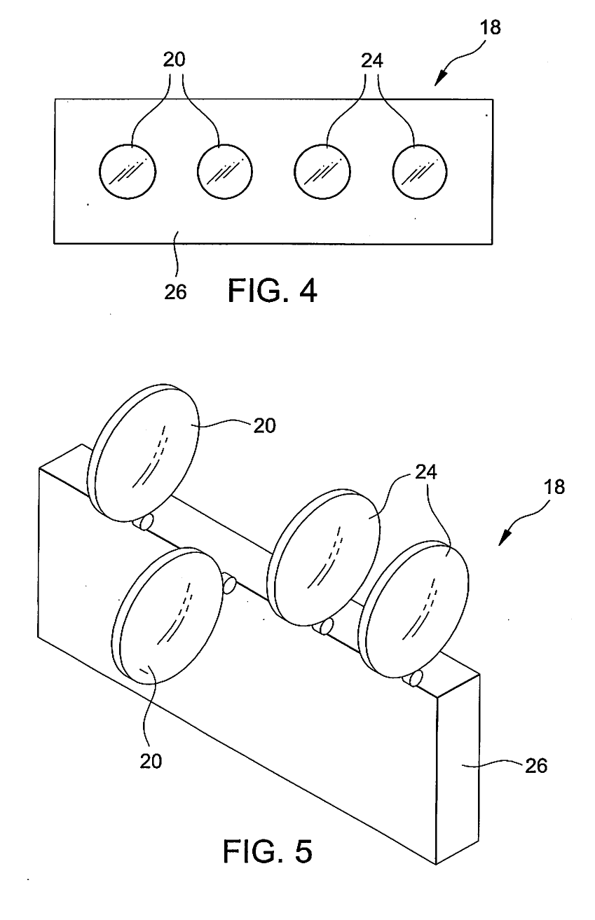

The support clement 26 shown in FIGS. 2 and 3 is a rotary element configured for rotation to place a desired lens in a position substantially coaxial with the optical axis 14. Other arrangements arc also envisioned. For example, the first and second lenses 20. 24 may be associated with a linear support element 26 configured for translation to place a desired lens in a position substantially coaxial with the optical axis 14, as shown in FIG. 4. Alternatively, the lenses may be pivotably mounted on a stationary support element 26, as shown in FIG. 5. In a still further embodiment, a complex support element may be configured for at least one translation and/or at least one rotation to place a desired lens in a position substantially coaxial with the optical axis 14. The actuation of the support elements described above may be carried out manually or may be automated using motors and, optionally, control hardware and/or software.

Some wavefront sensing methods utilize data from multiple images, each containing different levels of defocus. For those applications, a plurality of lenses having different levels of defocus may be utilized. In other applications, defocus image data may be obtained with the defocus element disposed at different locations along the optical axis. Two such locations are shown in FIG. 1, identified as Position 1 and Position 2. For those applications, multiple defocus elements 18 may be disposed at different locations between the optical element 12 and the focal plane 16. In another embodiment, a single defocus element 18 may be used, in which the support element 26 is movable along the optical axis 14.

In embodiments according to the invention, the at least one first lens 20 and the at least one second lens 24 each comprise at least one of a bi-convex lens, a bi-concave lens, a positive meniscus lens, a negative meniscus lens, a piano-convex lens, and a plano-concave lens. Other lens types may also be used.

In one embodiment, the at least one first lens 20 and the at least one second lens 24 comprise low powered lenses. As used herein, “low powered lenses” means lenses having a radius of curvature much greater than their diameter. In one example, a low powered lens was used for which the radius of curvature was 100 times the diameter. Low powered lenses having other radius of curvature-to-diameter ratios may also be used.

In the embodiment shown in FIG. 1, the optical system 10 further comprises a detector 28 disposed substantially in the focal plane 16 to detect the light beam passing through the optical element 12. As shown, the at least one first lens 20 and the at least one second lens 24 produce the positive defocus image and the negative defocus image, respectively, on the detector 28. In embodiments of the invention, the at least one first lens 20 and the at least one second lens 24 have focal lengths suitable for producing the positive defocus image and the negative defocus image, respectively, over an effective portion of the detector 28.

As used herein, “effective portion” means a portion large enough for the image to be resolved on the detector and small enough that the image is fully contained on the detector without being clipped. In one embodiment, the effective portion of the detector is between approximately 10% and approximately 90% of the detector area. In another embodiment, the effective portion of the detector is between approximately 30% and approximately 70% of the detector area. Other ranges may also be used.

### EXAMPLE

In one example, a defocus element 18 having a rotary support element 26 was used to support two first lenses 20 and two second lenses 24. The first lenses 20 comprised a bi-convex lens and a positive-meniscus lens, and the second lenses 24 comprised a negative-meniscus lens and a bi-concave lens. A summary of the lens parameters is provided in Table 1 below:

TABLE 1
Summary of Lens Parameters

| | | | | |
|---|---|---|---|---|
| Manufacturer: | Newport | Melles-Griot | Melles-Griot | Newport |
| Lens: | KBX088 | LMP053 | LMN053 | SBC016 |
| Glass: | BK7 | BK7 | BK7 | Silica |
| Nominal F/#: | 9.8 | 9.8 | 9.8 | 9.8 |
| Ray-Trace F/#: | 8.94 | 9.18 | 10.42 | 10.89 |
| Defocus: | +11.3 | +7.4 | −7.9 | −11.48 |
| (Zernike waves) | | | | |
| Design: | Bi-Convex | Positive- | Negative- | Bi-Concave |
| | | Meniscus | Meniscus | |

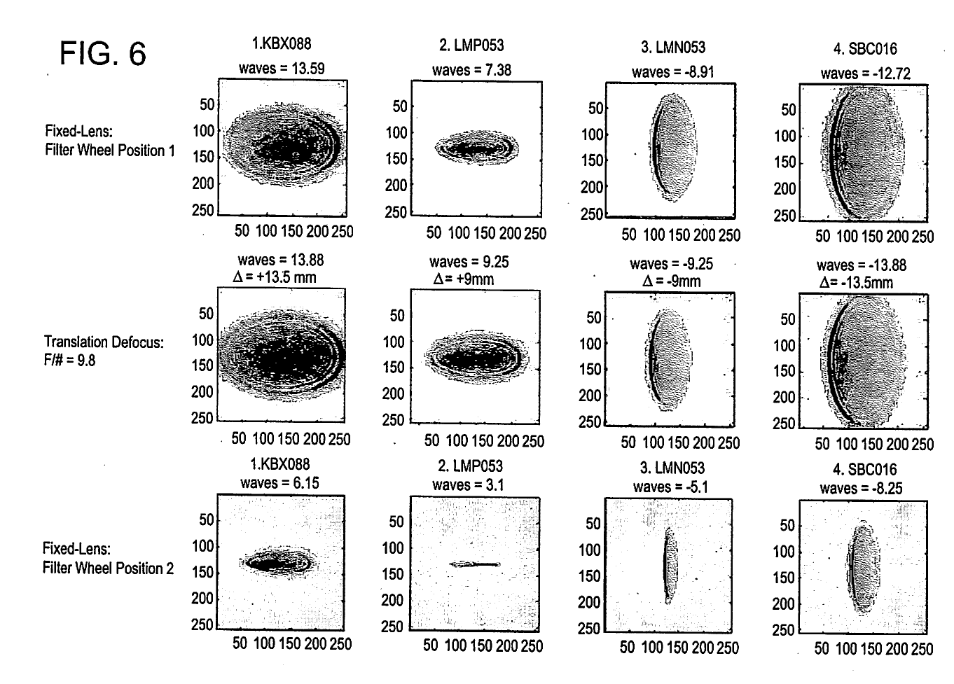

Defocus image data was obtained using the above-described defocus element 18, first at Position 1 shown in FIG. 1, then at Position 2. In addition, defocus data comparable to that obtained at Position 1 was obtained by translating the detector 28. The image data from those three sets in shown in FIG. 6.

It is noted that the image data from Position 1 and Position 2, while showing a change in defocus magnitude, showed that the positive and negative defocus orientations were maintained as the defocus element was moved along the optical axis 14.

It will be apparent to those skilled in the art that various modifications and variations can be made to the structure and methodology described herein. Thus, it should be understood that the invention is not limited to the examples discussed in the specification. Rather, the present invention is intended to cover modifications and variations.

1. A space-based optical system, comprising:
an optical element defining an optical axis and a focal plane; and
a defocus element disposed between the optical element and the focal plane, the defocus element comprising:
at least one first low powered lens for producing a positive defocus image of a light beam passing through the optical element, irrespective of a position of the first lens along the optical axis; and
at least one second low powered lens for producing a negative defocus image of the light beam passing through the optical element, irrespective of a position of the second lens along the optical axis.

2. The optical system of claim 1, wherein the optical element comprises at least one of a lens, a mirror, an imaging system, a camera, a detector and a laser.

3. The optical system of claim 1, wherein the at least one first lens and the at least one second lens are selectively movable to a position substantially coaxial with the optical axis.

4. The optical system of claim 1, wherein the defocus element further comprises a support element supporting the at least one first lens and the at least one second lens.

5. The optical system of claim 4, wherein at least one of a translation and a rotation of the support element selectively places a desired lens in a position substantially coaxial with the optical axis.

6. The optical system of claim 4, wherein the support element is movable along the optical axis.

7. The optical system of claim 1, wherein the at least one first lens and the at least one second lens each comprise at least one of a bi-convex lens, a bi-concave lens, a positive meniscus lens, a negative meniscus lens, a plano-convex lens, and a plano-concave lens.

8. (canceled)

9. The optical system of claim 1, wherein the at least one first lens comprises a plurality of first lenses.

10. The optical system of claim 1, wherein the at least one second lens comprises a plurality of second lenses.

11. The optical system of claim 1, further comprising a detector disposed substantially in the focal plane to detect the light beam passing through the optical element.

12. The optical system of claim 11, wherein the at least one first lens and the at least one second lens produce the positive defocus image and the negative defocus image, respectively, on the detector.

13. The optical system of claim 12, wherein the at least one first lens and the at least one second lens have focal lengths suitable for producing the positive defocus image and the negative defocus image, respectively, over an effective portion of the detector.

14. A space based optical system comprising:
an optical element defining an optical axis and a focal plane;
a detector disposed substantially in the focal plane to detect a light beam passing through the optical element; and
a defocus element disposed between the optical element and the detector, the defocus element comprising:
a support element;
a plurality of first low powered lenses associated with the support element for producing positive defocus images of the light beam on the detector, irrespective of the position of the plurality of first lenses along the optical axis; and
a plurality of second low powered lenses associated with the support element for producing negative defocus images of the light beam on the detector, irrespective of a position of the plurality of second lenses along the optical axis.

15. The optical system of claim 14, wherein the optical element comprises at least one of a lens, a mirror, an imaging system, camera, a detector, and a laser.

16. The optical system of claim 14, wherein each of the plurality of first lenses and each of the plurality of second lenses are selectively movable to a position substantially coaxial with the optical axis of the optical element.

17. The optical system of claim 14, wherein at least one of a translation and a rotation of the support element selectively places a desired lens in a position substantially coaxial with the optical axis of the optical element.

18. The optical system of claim 14, wherein the support element is movable along the optical axis.

19. The optical system of claim 14, wherein each of the plurality of first lenses and each of the plurality of second lenses comprise at least one of a bi-convex lens, a bi-concave lens, a positive meniscus lens, a negative meniscus lens, a piano-convex lens, and a plano concave lens.

20. (canceled)

21. The optical system of claim 14, wherein the plurality of first lenses and the plurality of second lenses have focal lengths suitable for producing the positive defocus images and negative defocus images, respectively, over an effective portion of the detector.
